(19) United States
(12) Patent Application Publication
(10) Pub. No.: US 2026/0177380 A1
(43) Pub. Date: Jun. 25, 2026

(54) DISPLAY METHODS, TECHNIQUES, SYSTEMS, AND APPARATUS FOR ELECTRONIC LEVELS

(71) Applicant: Franklin Sensors Inc., Meridian, ID (US)

(72) Inventors: David Dorrough, Eagle, ID (US); Natalie Boehm, Meridian, ID (US); Laura Boehm, Meridian, ID (US); Jay Paxman, Meridian, ID (US); Owen Barnes, Meridain, ID (US); Daniel Toborg, Meridian, ID (US); Jacob Thomas, Nampa, ID (US); Karen Garcia, Meridian, ID (US)

(73) Assignee: Franklin Sensors Inc., Meridian, ID (US)

(21) Appl. No.: 19/425,439

(22) Filed: Dec. 18, 2025

Related U.S. Application Data
(60) Provisional application No. 63/738,329, filed on Dec. 23, 2024.

(51) Int. Cl. G01C 9/04; G01D 7/06; G01D 11/24

(52) U.S. Cl. CPC G01C 9/04; G01D 7/06; G01D 11/245; G01D 2207/30

(57) ABSTRACT

Systems, apparatus, and methods for detecting levelness are disclosed. An electronic level can include one or more sensing elements configured to detect levelness of the electronic level. The electronic level can include a display including multiple output display elements arranged in an array that extends in a direction along a longitudinal axis of the electronic level and configured to display an indication of the levelness of the electronic level. The electronic level can include a controller coupled with the one or more sensing elements and the multiple output display elements. The controller may be configured to activate the one or more sensing elements to detect the levelness and activate one or more of the multiple output display elements to display the indication based on the levelness.

### CROSS REFERENCE TO RELATED APPLICATIONS

This application claims the benefit of priority under 35 U.S.C. § 119 (e) to U.S. Provisional Patent Application No. 63/738,329 titled “DISPLAY METHODS, TECHNIQUES, AND SYSTEMS FOR ELECTRONIC LEVELS,” filed Dec. 23, 2024, which is hereby incorporated herein by reference.

### BACKGROUND

Detecting levelness, for example levelness of an object, a plane, a surface, or levelness between objects, is often desirable and a common occurrence during construction, repair, renovation, and similar activities. For example, while installing a door frame, detecting that the door frame is horizontally and vertically level will support installing a more structurally sound door frame. If the door frame is installed without being level, the integrity and functionality of the door frame may be impeded. This and other scenarios make detecting levelness desirable. Levelness can be a measure of how parallel a surface is to the horizon or a specific reference plane; for example, an angle of inclination in relation to a reference surface.

A digital level may use electronic sensors, such as accelerometers, to detect levelness. A digital level may display a digital value (e.g., a number, a quantity) to represent a current angle of inclination of the digital level. The digital display may improve viewability. However, the nature of displaying the angle of the digital level may be non-intuitive in determining a magnitude and direction for correcting (e.g., moving) the digital level to efficiently (e.g., quickly, without error) reach a desired levelness. Thus, relying solely on the digital display of a digital level to adequately indicate levelness may result in inaccurate interpretation and/or lack of understanding in how to efficiently reach a desired levelness.

### SUMMARY

The disclosure herein provides systems, methods and techniques of detecting and displaying levelness of a surface and that may overcome the aforementioned and other difficulties of presently available systems, methods and techniques. For example, at least one aspect is directed to an electronic level system. The electronic level system may include one or more sensing elements to capture levelness data to be used for detecting levelness of the electronic level, a display configured to present a representation of the levelness of the electronic level, one or more levelness indicators to present a level indication to indicate the electronic level is level and to present a target indication to indicate the electronic level is at a custom reference of levelness, and a controller coupled with the one or more sensing elements, the display, and the one or more levelness indicators. The controller may be configured to activate the display to present the representation of levelness of the electronic level. The controller may be configured to activate the one or more levelness indicators according to the levelness. For example, the controller may activate the one or more levelness indicators to present the level indication if the electronic level is level. The controller may activate the one or more levelness indicators to present the target indication to indicate the electronic level is at a custom reference (or target) of levelness. In an aspect, the display comprises a digital display configured to provide a digital indication of the levelness of the electronic level.

In an aspect, the display is further configured to display (or present) an indication of the custom reference (or target) of levelness. In an aspect, the first (level) indication is a first color and the second (target) indication is a second color. In an aspect, the one or more levelness indicators each comprise a light emitting diode (LED). In an aspect, the one or more levelness indicators are further configured to present a third (intermediary) indication if the electronic level is detected to be at a levelness between level and the custom reference (or target) of levelness. In an aspect, the one or more levelness indicators are further configured to present an outlier indication if the electronic level is detected to be at a levelness that is not between level and the custom reference (or target) of levelness. In an aspect, the third indication is a third color. In an aspect, the electronic level further includes an input element (e.g., button) for receiving user input to set the custom reference (or target measure) of levelness.

At least one aspect is directed to a display for an electronic level. The display may include multiple output display elements arranged as a digital display to present or display an indication of the levelness of the electronic level based on input from one or more sensing elements of the electronic level. The display may include one or more levelness indicators to present a first (levelness) indication to indicate the electronic level is level and to present a second (target) indication to indicate the electronic level is at a custom reference of levelness. The display may include circuitry or a controller coupled with the display (e.g., multiple output display elements) and the one or more levelness indicators. The circuitry or controller can be configured to couple to the one or more sensing elements. The circuitry or controller may be configured to activate the one or more sensing elements to detect the levelness. The circuitry or controller may be configured to activate one or more of the multiple output display elements (e.g., to active the display) to display the indication based on the levelness. The circuitry or controller may be configured to activate the one or more levelness indicators according to the levelness. In an aspect, the circuitry or controller activates the one or more levelness indicators to present the first (level) indication if the electronic level is level and activates the one or more levelness indicators to present the second (target) indication to indicate the electronic level is at a custom reference (or target) of levelness.

The techniques described herein may result in various advantages over the aforementioned difficulties. For example, adopting the electronic level display may allow for increased ability and accuracy in determining the levelness of an object, intuitive determinations, increased visibility, and improved efficiency, among other advantages.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIGS. 1A and 1B are views of an electronic level system, according to one embodiment of the present disclosure.

FIGS. 2A-2C are views of an electronic level system, according to another embodiment of the present disclosure.

FIG. 3 is a diagram of a method for operation of an electronic level, according to one embodiment of the present disclosure.

### DETAILED DESCRIPTION

The techniques described herein may result in various advantages over the aforementioned difficulties. For example, adopting the electronic level display may allow for increased accuracy in determining the levelness of an object, intuitive determinations, increased visibility, and improved efficiency, among other advantages.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure.

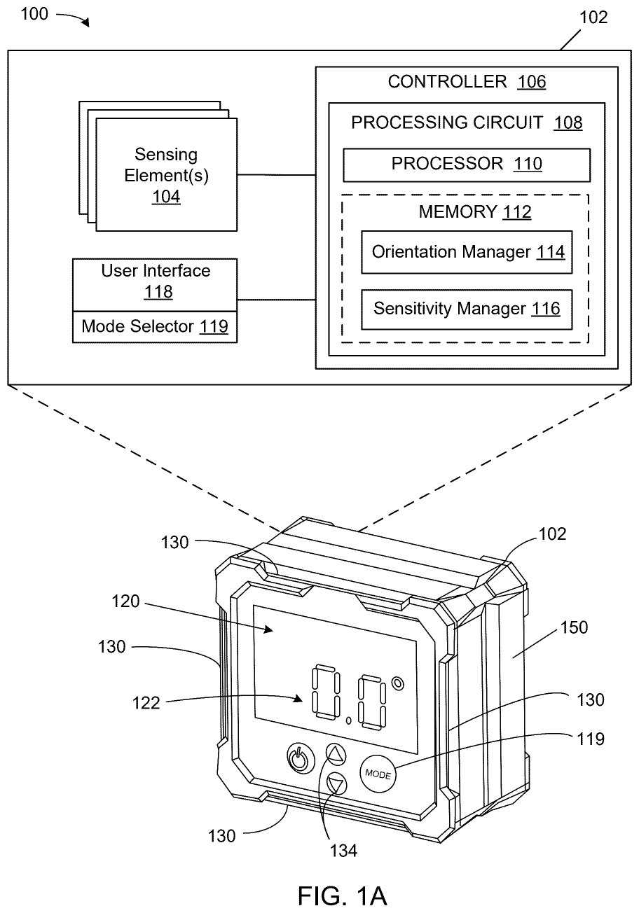

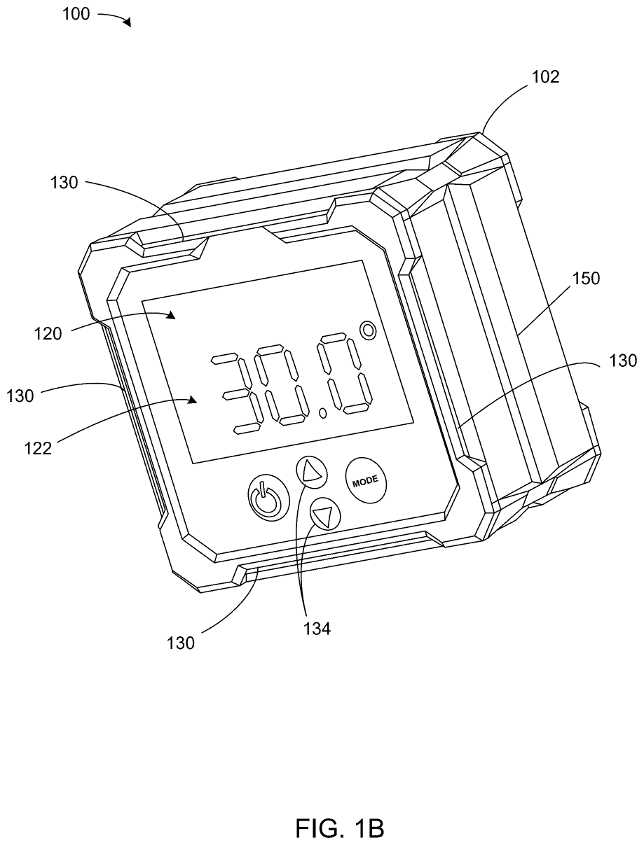

FIGS. 1A and 1B are views of an electronic level system 100, according to one embodiment. FIG. 1A is a front perspective view of the electronic level system 100, according to one embodiment, including a diagrammatic callout of components of the electronic level system 100. FIG. 1B is a front perspective view of the electronic level system 100 of FIG. 1A.

With reference to FIG. 1A, the system 100 can include an electronic level 102, and can one or more sensing elements 104, a controller 106, and/or a user interface 118. The controller 106 can include a processing circuit 108, a processor 110, and memory 112. The memory 112 can further include one or more engines, such as an orientation manager 114 and a sensitivity manager 116. In some embodiments, the system 100 includes a battery, wherein the system 100 is powered by the battery. In brief overview, components of the system 100 may support displaying an indication of levelness, such as including processing or otherwise using output (e.g., information, signals) from, the sensing elements 104. A housing 150 of the electronic level 120 can house or otherwise support the elements of the electronic level 120.

The sensing elements 104 can include sensors, apparatuses, hardware, components, or other elements to sense (e.g., detect, read) a levelness of the electronic level 102. In a first example, the sensing elements 104 may include one or more accelerometers. Accelerometers can sense various forces, such as gravitational forces on a body. Based on sensing the forces, the accelerometers or the controller 106 can determine levelness. In some cases, the accelerometers may sense in two axes or three axes. In another example, the sensing elements 104 may include lasers or lights. For example, light sensors may detect the light from the lasers or lights to determine a position of a bubble in a bubble vial. Based on the position, the sensing elements 104 or the controller 106 can determine levelness. In yet another example, the sensing elements 104 may include probes. For example, the probes may be inserted into a bubble vial to sense conductivity through the fluid of the bubble vial. Based on the conductivity, the sensing elements 104 may determine a position of the fluid in the vial and therefore the angle of the electronic level 102 (e.g., a levelness). In another example, the sensing elements 104 may include capacitive sensors. For example, the capacitive censors may sense capacitance of a bubble (e.g., by treating a body of liquid as a dielectric of a capacitor). By determining a position of the liquid in the bubble vial, the sensing elements 104 or the controller 106 may determine the levelness of the electronic level 102. In some aspects, the sensing elements 104 are mounted to a shock isolating media, which can be mounted to the electronic level 100.

In some embodiments, the sensing elements 104 may include a light sensor. The light sensor may determine whether the surrounding environment is a dim environment or a bright environment. For example, the light sensor may detect an amount (e.g., intensity, strength, wavelength) of light in an environment surrounding the electronic level 102.

The processing circuit 108 may be structured or configured to execute or implement instructions, commands, and/or control processes described herein with respect to the controller 106. The depicted configuration represents the processing circuit 108 as electronic circuitry, hardware, a processing chip, or the like. However, this illustration is not meant to be limiting as the present disclosure contemplates other embodiments (e.g., the processing circuit 108 may be configured as instructions stored in non-transitory machine or computer-readable media). All such combinations and variations are intended to fall within the scope of the present disclosure.

The processor 110 may be one or more of a single- or multi-chip processor, a digital signal processor (DSP), an application specific integrated circuit (ASIC), a field programmable gate array (FPGA), or other programmable logic device, discrete gate or transistor logic, discrete hardware components, another type of suitable processor, or any combination thereof designed to perform the functions described herein. In this way, the processor 110 may be a microprocessor, a state machine, or other suitable processor. The processor 110 also may be implemented as a combination of computing devices, such as a combination of a DSP and a microprocessor, a plurality of microprocessors, one or more microprocessors in conjunction with a DSP core, or any other such configuration. The memory 112 may store or otherwise include computer readable media that is accessible to the processor 110. The computer readable media can include code, which may be written in any programming language including, but not limited to, Java or the like and any conventional procedural programming languages, such as the “C” programming language or similar programming languages. The computer readable program code can be compiled, such as into machine code that is directly executable by the processor 110 and/or processing circuit 108. The computer readable program code may be executed by one processor, multiple processors, or multiple remote processors. In the latter scenario, the remote processors may be connected to each other through any type of network (e.g., CAN bus, etc.).

Alternatively, or additionally, the processor 110 may be structured to perform or otherwise execute certain operations independent of one or more co-processors. In some embodiments, two or more processors may be coupled via a bus to enable independent, parallel, pipelined, or multi-threaded instruction execution. All such variations are intended to fall within the scope of the present disclosure. In another configuration, the processing circuit 108 may be embodied as one or more circuitry components including, but not limited to, processing circuitry, network interfaces, peripheral devices, input devices, output devices, etc. In some embodiments, the processing circuit 108 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the processing circuit 108 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The memory 112 (e.g., memory, memory unit, storage device) may include one or more devices (e.g., RAM, ROM, Flash memory, hard disk storage) for storing data and/or computer code for completing or facilitating the various processes, layers, engines, and/or modules described in the present disclosure. The memory 112 may be communicatively coupled to the processor 110 to provide computer code or instructions to the processor 110 for executing at least some of the processes described herein. Moreover, the memory 112 may be or include tangible, non-transient volatile memory or non-volatile memory. Accordingly, the memory 112 may include database components, object code components, script components, or any other type of information structure for supporting the various activities and information structures described herein. For example, the memory 112 may include programmable instructions that, upon execution by the processor 110 and/or processing circuit 108, cause the system 100 to display an indication of levelness.

The user interface 118 can include input elements and/or output elements to facilitate a user in interfacing with the electronic level 102. For instance, the user interface 118 can include a display 120, one or more levelness indicators 130, and one or more input elements 134, as shown in FIG. 1A. The display 120 can include one or more display elements 122 (e.g., output elements) to display or otherwise present a representation of the levelness of the electronic level 102, as described more fully below. The one or more levelness indicators 130 (e.g., output elements) can present indications as to the levelness of the electronic level 102. The one or more input elements 134 can provide a mechanism or way for a user to provide input(s) to the electronic level 102.

With reference to FIGS. 1A and 1, the electronic level 102 can include a display 120 configured to display or otherwise present a representation or other indication of the levelness of the electronic level 102. The representation of the levelness can be a value. As shown in FIGS. 1A and 1, the display 120 of the illustrated embodiment presents a value of levelness in degrees from level. In other embodiments, the value of levelness can be a value of levelness in radians. In other embodiments, the value of levelness can be a value of levelness as a percentage. In other embodiments the representation can be graphical. In other embodiments, the representation can be symbolic. The display 120 can be configured to display the indication based on input from the one or more sensing elements 104. In an aspect, the input from the one or more sensing elements 104 can be a reading or measurement that is provided as an output of the one or more sensing elements 104. The display 120 can be a digital display, which can include one or more display elements (or output elements). In an example, the display 120 can be a liquid crystal display (LCD). In an aspect, the LCD can include a seven-segment LCD 122 (e.g., multiple output elements). In an aspect, the display 120 can be an LED display. The display 120 in FIG. 1A reflects or otherwise presents that the electronic level has a levelness of “0.0” degrees, or level. The display 120 in FIG. 1B reflects or otherwise presents that the electronic level 102 has a levelness of “30.0” degrees from level, indicating the electronic level 102 is not level and is at an angle relative to level or relative to a horizonal reference surface.

The one or more levelness indicators 130 are output elements that can present indications as to the levelness of the electronic level 102. The one or more levelness indicators 130 can present a first indication (e.g., a level indication) to indicate when the electronic level 102 is indeed level, or level within a threshold of sensitivity. FIG. 1A illustrates the electronic level 102 at a level state (e.g., 0.0 degrees) relative to a reference surface as shown on the display 120 and the one or more levelness indicators 130 accordingly present the level indication, such as illuminating with a color (e.g., green), a pattern, an arrangement, or other indication. The one or more levelness indicators 130 can present a second indication (e.g., a target indication, target levelness indication) to indicate when the electronic level 102 is at a target levelness or custom reference of levelness. FIG. 1B illustrates the electronic level 102 at an angle of 30.0 degrees relative to a reference surface as shown on the display 120. In an aspect, the target levelness or custom reference of levelness may be 30 degrees (although not reflected or presented on the display in FIGS. 1A and 1). In such case that the target levelness is 30 degrees, the one or more levelness indicators 130 accordingly present the target indication, such as illuminating with a color (e.g., blue), a pattern, an arrangement, or other indication.

The one or more levelness indicators 130 can present one or more additional indications to indicate where the levelness of the electronic level 103 is relative to the target levelness or custom reference of levelness. For example, the one or more levelness indicators 130 can present an intermediary indication if a present levelness of the electronic level 102 is between level and the target levelness or the custom reference of levelness. The one or more levelness indicators 130 can present an outlier indication if a present levelness of the electronic level 102 is not between level and the target levelness or the custom reference of levelness.

In an aspect, the first indication may be a first color and the second indication may be a second color. For example, the one or more levelness indicators 130 may display a green color when the level 102 is level (or at 0 degrees relative to a reference surface) and may display a blue color when the level 102 is at a target levelness or custom reference of levelness. As an example, the custom reference of levelness may be a target angle (e.g., 30 degrees) relative to the reference surface (e.g. a horizontal plane, vertical plane). When the one or more sensing elements 104 detect that the level 102 is at a 30 degree angle relative to a level horizontal surface, the one or more levelness indicators 130 may display a blue color.

In an aspect, the one or more levelness indicators 130 may illuminate. In another aspect, the one or more levelness indicators may include a light emitting diode (LED) technology. In an aspect, the one or more levelness indicators can illuminate in multiple colors. In an aspect, the one or more levelness indicators can illuminate in multiple patterns. In an aspect, the one or more levelness indicators can illuminate to multiple levels of brightness.

In an aspect, the one or more levelness indicators 130 are further configured to present a third (intermediary) indication if the electronic level 102 is detected to be at a levelness between level and the custom reference (or target measure) of levelness. For example, the one or more levelness indicators 130 may display a green color when the level 102 is level and may display a blue color when the electronic level 102 is at a custom reference of levelness and may display a red color when the electronic level is at an angle between 0.0° (level) and the custom reference angle. As an example, the custom reference of levelness may be a target angle (e.g., 30.0 degrees) relative to the reference surface (e.g. a horizontal plane). When the one or more sensing elements 104 detect that the electronic level 102 is at 0.0°, such as in FIG. 1A, the one or more levelness indicators 130 may display a green color. When the one or more sensing elements 104 detect that the level 102 is at 15.0° the one or more levelness indicators 130 may display a red color. And, when one or more sensing elements 104 detect that the level 102 is at 30.0° relative to a level horizontal surface, such as in FIG. 1B, the one or more levelness indicators 130 may display a blue color.

In an aspect, the one or more levelness indicators are further configured to present a third (intermediary) indication if the electronic level is detected to be at a levelness between level and the custom reference (or target measure) of levelness. For example, the first (levelness) indication can be a first color, the second (target) indication can be a second color, and the third (intermediary) indication can be a third color. In an aspect, the one or more levelness indicators 130 are further configured to present a third (outlier) indication if the electronic level 102 is detected to be at a levelness that is not between level and the custom reference (or target measure) of levelness. For example, the first (levelness) indication can be a first color, the second (target) indication can be a second color, and the third (outlier) indication can be a third color. If the custom reference (or target measure) of levelness were 30°, the third (outlier) indication may be presented if the electronic level were at 40°, which is not in between 0° (level) and 30° (the custom reference). Similarly, the third (outlier) indication may be presented as a third color if the electronic level were at −10° (or more simply 10° but angled in an opposite direction from the custom reference), which also would not in between 0° (level) and 30° (the custom reference).

In an aspect, the one or more levelness indicators are further configured to present a third (intermediary) indication if the electronic level is detected to be at a levelness between level and the custom reference (or target measure) of levelness and are further configured to present a fourth (outlier) indication if the electronic level 102 is detected to be at a levelness that is not between level and the custom reference (or target measure) of levelness. For example, the first (levelness) indication can be a first color (e.g., green), the second (target) indication can be a second color (e.g., blue), the third (intermediary) indication can be a third color (e.g. red), and the fourth (outlier) indication can be a fourth color (e.g., orange).

The electronic level 102 can further include an input elements 134 (e.g., input interface, input button). The one or more input elements 134 can provide a mechanism or way for a user to provide input(s) to the electronic level 102. In an aspect, one or more of the input elements 134 can be configured for receiving user input to set the custom reference (or target measure) of levelness. The input components 134 can include buttons (as shown in FIG. 1A), switches, a touchscreen, or any other appropriate mechanism for receiving input from a user. The input components 134 can enable various functions and functionality, including but not limited to toggling or otherwise selecting: the display, units of the display (e.g., degrees, radians, percentage levelness), a mode of the display, a mode of the electronic level, and the like. The input components 134 can enable providing a value (e.g., a target levelness or custom reference of levelness). In FIGS. 1A and 1B, the input elements 134 shown and can include one or more of power button, a mode selector, an up-arrow button, and a down-arrow button. The power button can activate (e.g., turn on, power up, wake up) the system 100 and/or the electronic level 102.

The user interface can include a mode selector 119. The mode selector may be configured to select a mode from a set of modes of the electronic level 102. The set of modes may include various modes of sensitivity for detecting levelness, a vertical mode, and/or or a horizontal mode. In some cases, the mode selector is a button, a switch, a touch display, or a component in wireless communication with a device (e.g., such that the device may transmit commands to the mode selector 119 to select the mode), among other possible implementations.

In some cases, the mode may be selected automatically by the mode selector 119 and/or the processing circuit 108. In some cases, the sensing elements 104 may detect the angle and determine an orientation of the electronic level 102. For example, the electronic level 102 and a plane (which may serve as a reference surface) may be oriented vertically (e.g., rather than the horizontal orientation). The sensing elements may detect the vertical orientation of the electronic level 102 and automatically select (e.g., switch to) an orientation mode from a set of orientation modes. In some examples, the sensing elements 104 may detect an orientation value. Based on whether the orientation value satisfies an orientation threshold (e.g., the electronic level is oriented at greater than a 45-degree angle in relation to a horizontal plane), the electronic level 102 may select a first orientation mode (e.g., a vertical mode) or a second orientation mode (e.g., a horizontal mode).

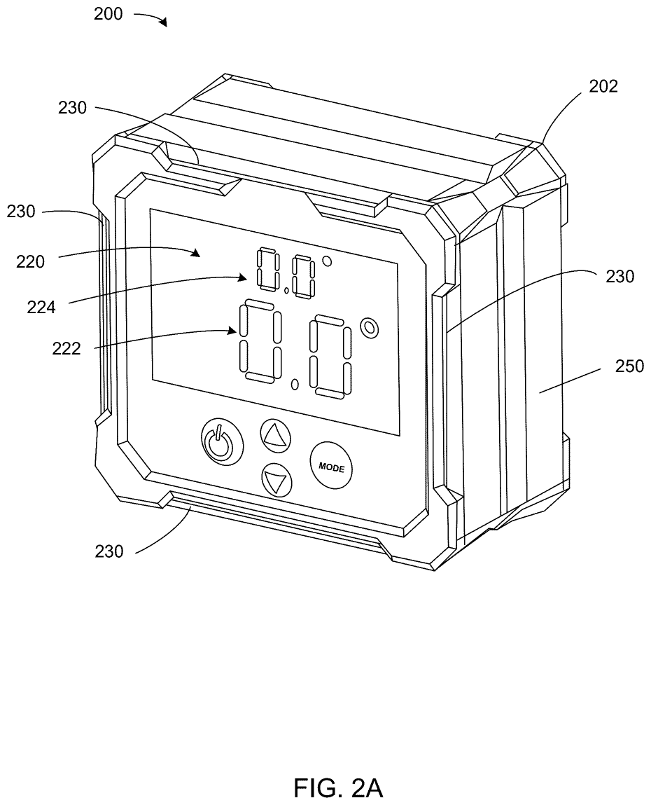

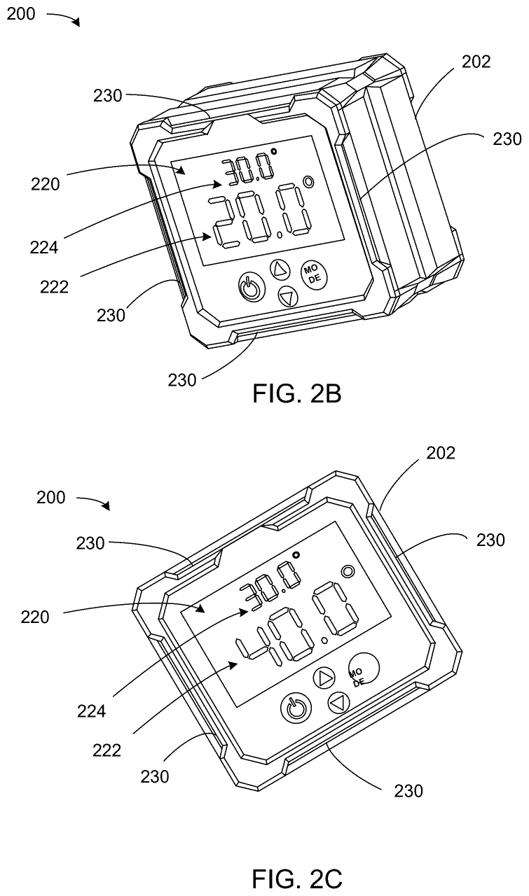

FIGS. 2A-2C are views of an electronic level system 200, according to another embodiment. The electronic level system 200 displays a custom reference (or target levelness) of levelness. In the example illustrated by FIGS. 2A-2C, the custom reference of levelness is 30°, as presented at the top of the display 220 in a slightly smaller font than the representation of the present levelness also presented on the display 220.

FIG. 2A is a front perspective view of the electronic level system 200, according to one embodiment, in a level state and reflecting that the electronic level 202 is level, as represented by 0.0° on a display 220. The display 220 presents “0.0” on a primary seven-segment LCD 222 to indicate a present levelness of zero, or that the electronic level 202 is in fact level, and presents “0.0” on a secondary seven-segment LCD 224 to indicate a custom reference of levelness (or target levelness) is 0 degrees or level, or to indicate that the custom reference of levelness has not yet been provided or set.

FIG. 2B is a front perspective view of the electronic level system 200 in an angled state and reflecting that the electronic level 202 is at an angle relative to level. The levelness of the electronic level system 200 in FIG. 2B is indicated as 20.0° relative to level, as presented by the display 220. The display 220 presents “20.0” on the primary seven-segment LCD 222 to indicate a present levelness of 20 degrees, and presents “30.0” on the secondary seven-segment LCD 224 to indicate a custom reference of levelness (or target levelness) of 30 degrees.

FIG. 2C is a front view of the electronic level system 200 of FIG. 2A with the electronic level 202 at a greater angle relative to level than illustrated in FIG. 2B. The levelness of the electronic level system 200 in FIG. 2C is indicated as 40.0° relative to level, as presented by the display 220. The display 220 presents “40.0” on the primary seven-segment LCD 222 to indicate a present levelness of 40 degrees, and presents “30.0” on the secondary seven-segment LCD 224 to indicate a custom reference of levelness (or target levelness) of 30 degrees.

With reference to FIGS. 2A-2C, the electronic level 202 can include a display 220 configured to display or otherwise present an indication of the levelness of the electronic level 202. The display 220 can be configured to display the indication according to levelness data from or captured by one or more sensing elements. The display 220 can be a digital display. In an example, the display 220 can be a liquid crystal display (LCD). In an aspect, the LCD can include a primary seven-segment LCD 222 to present the present levelness of the electronic level 202. In an aspect the LCD can include a secondary seven-segment LCD 224 to present the custom reference (or target measure) of levelness. In an aspect, the secondary seven-segment LCD 224 may differ from the primary seven-segment LCD 222, such as varying in size, color, brightness, shape, font, or the like. In FIG. 2A the display 220 presents “0.0°” on the primary seven-segment LCD 222 to indicate a present levelness of zero, or that the electronic level 202 is in fact level, and presents “0.0°” on the secondary seven-segment LCD 224 to indicate a custom reference of levelness (or target levelness) is 0 degrees or level, or to indicate that the custom reference of levelness has not yet been provided. In FIG. 2B, the display 220 presents “20.0°” on the primary seven-segment LCD 222 to indicate that the present levelness of the electronic level 202 is 20 degrees from level, or at an angle of 20.0 degrees relative to a horizonal reference surface or other reference surface. In FIG. 2C, the display 220 presents “40.0°” on the primary seven-segment LCD 222 to indicate that the present levelness of the electronic level 202 is 40 degrees from level, or at an angle of 40.0 degrees relative to a horizonal reference surface or other reference surface. In both FIGS. 2B and 2C, the display 220 presents “30.0” to indicate that the custom reference (or target measure) of levelness is thirty (30.0) degrees from level or at an angle of 30.0° relative to a horizonal reference surface or other reference surface. In another embodiment, the display 220 can be an LED display.

The electronic level 202 can include one or more levelness indicators 230 configured to present a first (level) indication to indicate the electronic level 202 is level and to present a second (target) indication to indicate the electronic level 202 is at a custom reference of levelness. In an aspect, the first (level) indication may be a first color and the second (target) indication may be a second color. For example, the one or more levelness indicators 230 may display a green color when the level 202 is level (e.g., as in FIGS. 1A and 2A) and may display a blue color when the level 202 is at the custom reference of levelness (e.g., as in FIG. 1B. As an example, the custom reference of levelness in FIGS. 2B-2C can be a target angle (e.g., 30 degrees) relative to the reference surface (e.g. a horizontal plane). When the one or more sensing elements detect that the level 202 is at a 30 degree angle relative to a level horizontal surface, the one or more levelness indicators 230 may display a blue color.

FIG. 2B illustrates the electronic level 202 at a levelness of 20.0°, which is between level (0.0°) and the custom reference of levelness (30.0°). In an aspect, the one or more levelness indicators 230 are configured to present a third (intermediary) indication if the electronic level 202 is detected to be at a levelness between level and the custom reference (or target measure) of levelness. For instance, the levelness indicators 230 can provide a third color (e.g., red) to indicate that the present levelness of the electronic level 202 is between a level state and a levelness of the custom reference, such as in FIG. 2B.

FIG. 2C illustrates the electronic level 202 at a levelness of 40.0°, which is outside of the range between (e.g. not between) level (0.0°) and the custom reference of levelness (30.0°). In an aspect, the one or more levelness indicators 230 are configured to present a fourth (outlier) indication if the electronic level 202 is detected to be at a levelness that is not between level and the custom reference (or target measure) of levelness. For instance, the levelness indicators 230 can provide a fourth color (e.g., orange) to indicate that the present levelness of the electronic level 202 is between a level state and a levelness of the custom reference, such as in FIG. 2B. For example, the first (levelness) indication can be a first color (e.g., green), the second (target) indication can be a second color (e.g., blue), the third (intermediary) indication can be a third color (e.g. red), and the fourth (outlier) indication can be a fourth color (e.g., orange).

The electronic level 202 can include a housing 250 to house one or more sensing elements, a controller, and other components. The housing 250 can support the display 220 for convenience in viewing. The housing 250 can support the one or more levelness indicators 230 for convenience in viewing. In an embodiment, the one or more levelness indicators 230 are integral to or otherwise integrated into the housing 250. In an example, the housing 250 can include one or more levelness indication portions. The one or more levelness indication portions can each be one or more of transparent, semitransparent, or translucent such that they can illuminate. In an aspect, the one or more levelness indicators 230 cause the one or more levelness indication portions of the housing 250 to illuminate (or glow) according to the one or more levelness indicators. In an aspect, the one or more levelness indicators 230 are to illuminate to cause the one or more levelness indication portions of the housing 250 to illuminate (or glow) to present the first (levelness) indication to indicate the electronic level 202 is level and to illuminate (or glow) to present the second (target) indication to indicate the electronic level 202 is at a custom reference of levelness. In an aspect, the one or more levelness indicators are to illuminate a first color to cause the one or more levelness indication portions of the housing to illuminate (or glow) in the first color to present the first (levelness) indication and to illuminate a second color to cause the one or more levelness indication portions of the housing to illuminate (or glow) in the second color to present the second (target) indication.

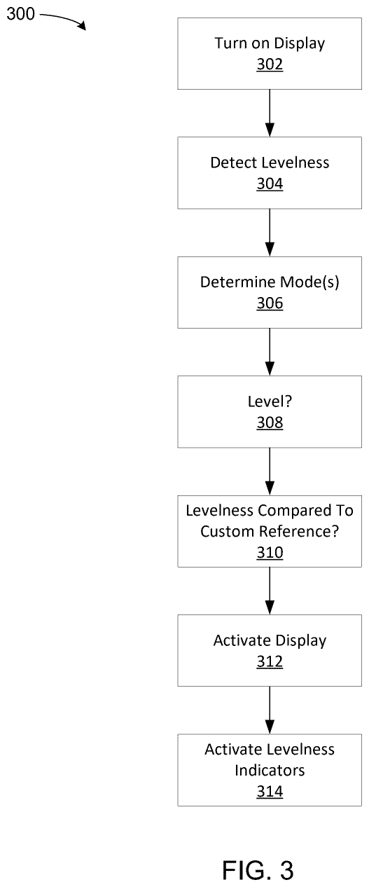

FIG. 3 is a flow diagram of a method 300 of an electronic level system, according to one embodiment. The method 300 includes execution steps 302-312. However, it should be appreciated that other embodiments may comprise additional or alternative steps, or may omit one or more steps altogether. It should also be appreciated that other embodiments may include certain execution steps in a different order. Steps discussed herein may also be performed simultaneously or near-simultaneously. FIG. 3 is described as being performed by a controller of the electronic system that is coupled with one or more sensing elements and one or more display elements. In some cases, the display elements may include a display and one or more levelness indicators of an electronic level.

At step 302, the controller turns on a display. A user of the electronic level system may provide user input directing that the electronic level system turn on. For example, the user may press a button (e.g., flip a switch, press a touch display element, etc.). Based on the user input, the controller may turn on the display and activate sensing elements and the display elements (e.g., pull power from a battery of the electronic level system). The controller also may set a custom reference (or target measure) of levelness, e.g., based on user input, a default, historical data, or the like.

At step 304, the sensing elements detect a levelness of the electronic level system. For example, the sensing elements may detect the levelness via a laser lasers or lights to determine a position of a bubble in a bubble vial, one or more accelerometers, one or more probes, one or more capacitive sensors, or any combination thereof, as described herein.

At step 306, the controller may determine one or more modes. The controller may determine the modes based on the detected levelness of the sensing elements. For example, the controller may determine an orientation of the electronic level based on the levelness. If the orientation of the electronic level is mostly vertical, horizontal, upside down, or right side up, the electronic level may select a corresponding mode of operation. In some cases, the controller may determine a sensitivity mode based on user input or may be preconfigured with the sensitivity mode. For example, the electronic level may default to a first sensitivity mode of a set of sensitivity modes. The user may provide user input (e.g., via a button, switch, touch display element) to select another sensitivity mode from the set of sensitivity modes.

At step 308, levelness of the electronic level is detected or otherwise determined. In one embodiment, the controller determines whether the one or more sensing elements detect a levelness that indicates the electronic level is level. In another embodiment, the one or more sensing elements obtain levelness data to be used for detecting levelness and one or more of the controller, a processing circuit, and/or a processor can use the levelness data to determine the levelness. In one aspect, the controller may compare a value of a present levelness to a value for a level state (e.g., 0.0°).

At step 310, the controller determines whether the detected levelness is greater than, equal to, or less than a custom reference (or target measure) of levelness. In one embodiment, the controller compares a value for the present levelness to a value for the custom reference.

At step 312, the controller activates a display to present an indication of levelness. In an aspect, the controller can activate a display to present on a primary portion of the display (e.g., a primary seven-segment LCD) a representation of the present levelness. The representation can be a value for the present levelness. The value can be in degrees, radians, FL number, or any appropriate value in any appropriate unit. Correspondingly, the controller can activate the display to present an indication of a custom reference of levelness (or target levelness), which may be provided by user input. In an aspect, the controller can activate a display to present on a secondary portion of the display (e.g., a secondary seven-segment LCD) a representation of the custom reference of levelness. The representation can be a value for the custom reference of levelness, which be in units that correspond to units of the value for the present levelness.

At step 314, the controller may activate (e.g., turn on) the one or more levelness indicators to provide an indication of levelness. The one or more levelness indicators can be configured to present a first (level) indication to indicate the electronic level is level, or substantially level within a threshold. The one or more levelness indicators can be configured to present a second (target) indication to indicate the electronic level is at the custom reference of levelness, or within a threshold of the same. In an aspect, the first (level) indication may be a first color and the second (target) indication may be a second color. For example, the one or more levelness indicators may display a green color when the level is level and may display a blue color when the level is at a custom reference of levelness. As an example, the custom reference of levelness may be a target angle (e.g., 30 degrees) relative to the reference surface (e.g. a horizontal plane). When the one or more sensing elements detect that the level is at a 30 degree angle relative to a level horizontal surface, the one or more levelness indicators 130 may display a blue color. In another example, the one or more levelness indicators 130 may provide the first indication and the second indication according to a pattern or arrangement. For instance, the one or more levelness indicators 130 may present in an arrangement of a first (e.g. top) levelness indicator illuminating to indicate the levelness is level while the other one or more levelness indicators 130 remain unlit and a pair (e.g., two lateral levelness indicators) of the one or more levelness indicators 130 may illuminate to indicate the levelness is at the custom reference of levelness. In another instance, one or more of the one or more levelness indicators 130 may flash in a pattern to provide a levelness indication. For instance a consistent steady alternating illumination and then darkening of the one or more levelness indicators 130 in unison may indicate the levelness state is level and a rotating illumination of each of the indicators 130 in isolation may indicate a custom reference of levelness has been achieved. As can be appreciated, other arrangements and/or patterns are possible and within the scope of the present disclosure.

Some example embodiments of the systems, apparatus, methods, and the like, of the present disclosure are provided as follows:

An electronic level, according to one embodiment, comprises: one or more sensing elements configured to capture levelness data to be used for detecting levelness of the electronic level, a display (e.g. a digital display) to present a representation of (e.g., a value representing) the levelness of the electronic level, one or more (e.g., a plurality of) levelness indicators (e.g., output elements) to present a first indication (e.g., a level indication) to indicate the electronic level is in a level state and to present a second indication (e.g., target indication) to indicate the electronic level is at a custom reference of levelness; and a controller (or similar circuitry). The controller can be coupled with the one or more sensing elements, the display, and the one or more levelness indicators.

The controller can be configured to detect, according to the levelness data captured by the one or more sensing elements, the levelness of the electronic level. The controller can be configured to activate the display to present the representation of the detected levelness of the electronic level. The controller can be configured to activate the one or more levelness indicators according to the detected levelness of the electronic level, including activating the one or more levelness indicators to present the first indication if the electronic level is level and activating the one or more levelness indicators to present the second indication (e.g., target indication, target levelness indication) if the electronic level is at a custom reference of levelness or target levelness.

The display of the electronic level can comprise a digital display configured to provide a digital indication of the levelness of the electronic level. The display can be further configured to display or otherwise present a representation of (e.g., indication of, value representing) the custom reference of levelness. The first indication can be a first color and the second indication can be a second color. The one or more levelness indicators can each comprise a light emitting diode (LED). The one or more levelness indicators can be configured to present a third indication (e.g., an intermediary indication) if the electronic level is detected to be at a levelness between level and the custom reference of levelness. The one or more levelness indicators can be configured to present a third indication (e.g., an outlier indication) if the electronic level is detected to be at a levelness that is not between level and the custom reference of levelness. The first indication can be a first color, the second indication can be a second color, and the third indication can be a third color. The electronic level can include a housing to house the one or more sensing elements and controller and to support the display, wherein the one or more levelness indicators are integrated with the housing.

In another aspect, the electronic level can include a housing to house the one or more sensing elements and controller and to support the display, and the housing can include one or more levelness indication portions each of which is one of transparent, semitransparent, or translucent, wherein the one or more levelness indicators are integrated with the housing to cause the one or more levelness indication portions of the housing to illuminate according to the one or more levelness indicators. The one or more levelness indicators can be configured to illuminate to cause the one or more levelness indication portions of the housing to glow (or illuminate) to present the first indication to indicate the electronic level is level and to glow (or illuminate) to present the second indication to indicate the electronic level is at the custom reference of levelness. The one or more levelness indicators can be configured to illuminate a first color to cause the one or more levelness indication portions of the housing to illuminate to present the first indication and to illuminate a second color to cause the one or more levelness indication portions of the housing to illuminate to present the second indication.

The representation of the levelness of the electronic level can comprise a measured value.

The controller can be configured to activate the one or more sensing elements of the electronic level.

The electronic level can include an input element, such as an input interface, an input button, or the like, for receiving user input to set the custom reference of levelness.

A display for an electronic level, according to one embodiment of the present disclosure, can include a digital display to provide a digital indication of the levelness of the electronic level based on input from one or more sensing elements of the electronic level, one or more levelness indicators to illuminate to present a first indication to indicate the electronic level is level and to illuminate to present a second indication to indicate the electronic level is at a custom reference of levelness, and circuitry coupled with the digital display and the one or more levelness indicators and configured to couple to the one or more sensing elements of the electronic level. The circuitry can be configured to activate the digital display to display the digital indication of a detected levelness of the electronic level.

The circuitry can be configured to activate the one or more levelness indicators according to the detected levelness of the electronic level, wherein the controller activates the one or more levelness indicators, if the electronic level is level, to illuminate to present the first indication to indicate the electronic level is level and activates the one or more levelness indicators to illuminate to present the second indication to indicate the electronic level is at a custom reference of levelness.

The display can include a body comprising one or more levelness indication portions each of which is one of transparent, semitransparent, or translucent, wherein the one or more levelness indicators illuminate the one or more levelness indication portions to present the first indication to indicate the electronic level is level and to present the second indication to indicate the electronic level is at the custom reference of levelness.

The digital display can be further configured to provide a digital indication of the custom reference of levelness.

The first indication can be a first color and the second indication can be a second color. The one or more levelness indicators can each comprise a light emitting diode.

The one or more levelness indicators can present a third indication (e.g., an intermediary indication) if the electronic level is detected to be at a levelness between level and the custom reference of levelness. The one or more levelness indicators can present a third indication (e.g., an outlier indication) if the electronic level is detected to be at a levelness that is not between level and the custom reference of levelness. The first indication can be a first color, the second indication can be a second color, and the third indication can be a third color.

The circuitry can be configured to activate one or more sensing elements of the electronic level. The circuitry can be configured to receive, from the one or more sensing elements of the electronic level, levelness data captured by the one or more sensing elements and detect the levelness of the electronic level, according to the levelness data.

An electronic level, according to one embodiment of the present disclosure can include one or more sensors configured to detect a levelness of the electronic level, a digital display to present a value representing the levelness, one or more levelness indicators to provide a level indication to indicate if the electronic level is level and a target indication to indicate if the electronic level is at a custom reference of levelness, and circuitry coupled with the one or more sensors, the digital display, and one or more levelness indicators. The one or more levelness indicators can include a level indicator to provide the level indication to indicate if the electronic level is level and a target indicator to provide the target indication to indicate if the electronic level is at a target levelness.

The circuitry can activate the one or more levelness indicators according to the levelness, wherein the one or more levelness indicators present the level indication if the electronic level is level and present the one or more levelness indicators to present the second indication if the electronic level is at a target levelness. The circuitry can activate the digital display to present the value representing the levelness. The circuitry can activate the one or more sensors to detect the levelness.

The digital display can display a representation of the custom reference of levelness. The first indication can be a first color and the second indication can be a second color. The one or more levelness indicators can each comprise a light emitting diode (LED).

The one or more levelness indicators can be further configured to present a third indication if the electronic level is detected to be at a levelness between level and the custom reference of levelness. The one or more levelness indicators can be further configured to present a third indication if the electronic level is detected to be at a levelness that is not between level and the custom reference of levelness. The first indication can be a first color, the second indication can be a second color, and the third indication can be a third color.

The electronic level can include a housing to house the one or more sensing elements and circuitry and to support the digital display, wherein the one or more levelness indicators are integrated with the housing. The electronic level can further include a housing to house the one or more sensing elements and circuitry and to support the digital display, the housing including the one or more levelness indication portions each of which is one of transparent, semitransparent, or translucent, wherein the one or more levelness indicators are integrated with the housing to cause the one or more levelness indication portions of the housing to illuminate according to the one or more levelness indicators. The one or more levelness indicators can be configured to illuminate to cause the one or more levelness indication portions of the housing to glow or otherwise illuminate to present the first indication to indicate the electronic level is level and to glow to present the second indication to indicate the electronic level is at the custom reference of levelness. The one or more levelness indicators can be configured to illuminate a first color to cause the one or more levelness indication portions of the housing to illuminate to present the first indication and to illuminate a second color to cause the one or more levelness indication portions of the housing to illuminate to present the second indication.

The representation of the levelness of the electronic level can comprise a measured value.

The circuitry can be configured to activate the one or more sensing elements of the electronic level.

The electronic level can include an input element for receiving user input to set the custom reference of levelness.

The foregoing detailed description includes illustrative examples of various aspects and implementations and provides an overview or framework for understanding the nature and character of the claimed aspects and implementations. The drawings provide illustration and a further understanding of the various aspects and implementations and are incorporated in and constitute a part of this specification.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). The operations described in this specification can be implemented as operations performed by a data processing apparatus on data stored on one or more computer-readable storage devices or received from other sources.

The terms “controller” or “component” encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks. The processor and the memory can be supplemented by, or incorporated in, special purpose logic circuitry.

While operations are depicted in the drawings in a particular order, such operations are not required to be performed in the particular order shown or in sequential order, and all illustrated operations are not required to be performed. Actions described herein can be performed in a different order. The separation of various system components does not require separation in all implementations, and the described program components can be included in a single hardware or software product.

The phraseology and terminology used herein is for the purpose of description and should not be regarded as limiting. Any references to implementations or elements or acts of the systems and methods herein referred to in the singular may also embrace implementations including a plurality of these elements, and any references in plural to any implementation or element or act herein may also embrace implementations including only a single element. Any implementation disclosed herein may be combined with any other implementation or embodiment.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

The foregoing implementations are illustrative rather than limiting of the described systems, apparatus, and methods. Scope of the systems, apparatus, and methods described herein is thus indicated by the appended claims, rather than the foregoing description, and changes that come within the meaning and range of equivalency of the claims are embraced therein.

What is claimed is:

1. An electronic level, comprising:
one or more sensing elements configured to capture levelness data to be used for detecting levelness of the electronic level;
a display to present a representation of the levelness of the electronic level;
one or more levelness indicators to present a first indication to indicate the electronic level is level and to present a second indication to indicate the electronic level is at a custom reference of levelness; and
a controller coupled with the one or more sensing elements, the display, and the one or more levelness indicators, the controller configured to:
detect, according to the levelness data captured by the one or more sensing elements, the levelness of the electronic level;
activate the display to present the representation of the levelness of the electronic level; and
activate the one or more levelness indicators according to the levelness of the electronic level, including activating the one or more levelness indicators to present the first indication if the electronic level is level and activating the one or more levelness indicators to present the second indication if the electronic level is at a custom reference of levelness.

2. The electronic level of claim 1, wherein the display comprises a digital display configured to provide a digital indication of the levelness of the electronic level.

3. The electronic level of claim 1, wherein the display is further configured to display a representation of the custom reference of levelness.

4. The electronic level of claim 1, wherein the first indication is a first color and the second indication is a second color.

5. The electronic level of claim 1, wherein the one or more levelness indicators each comprise a light emitting diode (LED).

6. The electronic level of claim 1, wherein the one or more levelness indicators are further configured to present a third indication if the electronic level is detected to be at a levelness between level and the custom reference of levelness.

7. The electronic level of claim 1, wherein the one or more levelness indicators are further configured to present a third indication if the electronic level is detected to be at a levelness that is not between level and the custom reference of levelness.

8. The electronic level of claim 7, wherein the first indication is a first color, the second indication is a second color, and the third indication is a third color.

9. The electronic level of claim 1, further comprising:
a housing to house the one or more sensing elements and controller and to support the display,
wherein the one or more levelness indicators are integrated with the housing.

10. The electronic level of claim 1, further comprising:
a housing to house the one or more sensing elements and controller and to support the display, the housing including the one or more levelness indication portions each of which is one of transparent, semitransparent, or translucent,
wherein the one or more levelness indicators are integrated with the housing to cause the one or more levelness indication portions of the housing to illuminate according to the one or more levelness indicators.

11. The electronic level of claim 10, wherein the one or more levelness indicators are to illuminate a first color to cause the one or more levelness indication portions of the housing to illuminate to present the first indication and to illuminate a second color to cause the one or more levelness indication portions of the housing to illuminate to present the second indication.

12. The electronic level of claim 1, wherein the representation of the levelness of the electronic level comprises a measured value.

13. The electronic level of claim 1, wherein the controller is further configured to activate the one or more sensing elements of the electronic level.

14. The electronic level of claim 1, further comprising an input element for receiving user input to set the custom reference of levelness.

15. A display for an electronic level comprising:
a digital display to provide a digital indication of the levelness of the electronic level based on input from one or more sensing elements of the electronic level;
one or more levelness indicators to illuminate to present a first indication to indicate the electronic level is level and to illuminate to present a second indication to indicate the electronic level is at a custom reference of levelness; and
circuitry coupled with the digital display and the one or more levelness indicators and configured to couple to the one or more sensing elements of the electronic level, the circuitry configured to:
activate the digital display to display the digital indication of a detected levelness of the electronic level; and
activate the one or more levelness indicators according to the detected levelness of the electronic level, wherein the controller activates the one or more levelness indicators, if the electronic level is level, to illuminate to present the first indication to indicate the electronic level is level and activates the one or more levelness indicators to illuminate to present the second indication to indicate the electronic level is at a custom reference of levelness.

16. The display of claim 15, further comprising:
a body comprising one or more levelness indication portions each of which is one of transparent, semitransparent, or translucent,
wherein the one or more levelness indicators illuminate the one or more levelness indication portions to present the first indication to indicate the electronic level is level and to present the second indication to indicate the electronic level is at the custom reference of levelness.

17. The display of claim 15, wherein the digital display is further configured to provide a digital indication of the custom reference of levelness.

18. The display of claim 15, wherein the first indication is a first color and the second indication is a second color.

19. The display of claim 15, wherein the one or more levelness indicators each comprise a light emitting diode.

20. The display of claim 15, wherein the one or more levelness indicators are further configured to present a third indication if the electronic level is detected to be at a levelness between level and the custom reference of levelness.

21. The display of claim 15, wherein the one or more levelness indicators are further configured to present a third indication if the electronic level is detected to be at a levelness that is not between level and the custom reference of levelness.

22. The display of claim 21, wherein the first indication is a first color, the second indication is a second color, and the third indication is a third color.

23. The display of claim 15, wherein the circuitry is further configured to activate one or more sensing elements of the electronic level.

24. The display of claim 15, wherein the circuitry is further configured to:
receive, from the one or more sensing elements of the electronic level, levelness data captured by the one or more sensing elements; and
detect the levelness of the electronic level, according to the levelness data.
